(19) United States
(12) Patent Application Publication
(10) Pub. No.: US 2025/0034373 A1
(43) Pub. Date: Jan. 30, 2025

(54) RUBBER COMPOSITION FOR TIRES

(71) Applicant: THE YOKOHAMA RUBBER CO., LTD., HIRATSUKA-SHI, KANAGAWA (JP)

(72) Inventors: Ayaki KAZARIYA, HIRATSUKA SHI, KANAGAWA (JP); Ryota HIGUCHI, HIRATSUKA SHI, KANAGAWA (JP); Hiroki SUGIMOTO, HIRATSUKA SHI, KANAGAWA (JP)

(21) Appl. No.: 18/717,049

(22) PCT Filed: Dec. 7, 2022
(86) PCT No.: PCT/JP2022/045073

§ 371 Date: Jun. 6, 2024

(30) Foreign Application Priority Data
Dec. 8, 2021 (JP) 2021-199169

(51) Int. Cl. C08L 9/06; B60C 1/00; C08K 3/36; C08L 7/00

(52) U.S. Cl. CPC C08L 9/06; B60C 1/0016; C08K 3/36; C08L 7/00; C08K 2201/006

(57) ABSTRACT

Provided is a rubber composition for tires providing low rolling resistance and wear resistance in a compatible manner. A rubber composition for tires is characterized by containing from 30 to 200 parts by mass of silica in 100 parts by mass of a diene rubber containing from 30 to 70 mass % of a modified styrene-butadiene rubber having an alkoxysilyl group. When measured by gel permeation chromatography, the modified styrene-butadiene rubber has a molecular weight distribution curve of a unimodal shape and the molecular weight distribution (PDI) of less than 1.7. A vinyl content is from 10 to 45 mass %. A glass transition temperature of the rubber composition for tires is −50° C. or lower.

### TECHNICAL FIELD

The present invention relates to a rubber composition for tires providing low rolling resistance and wear resistance in a compatible manner.

### BACKGROUND ART

In recent years, a tire concerning global environment is required to have excellent fuel economy performance, that is, smaller rolling resistance; however, meanwhile, it is important to ensure basic performance such as grip performance and durability to a degree equal to or higher than known products. For example, winter tires are required to have performance such as dry performance, wet performance, and wear resistance in a well-balanced manner to a high degree as well as performance on snow. To improve dry performance and wet performance, there is a method for increasing loss tangent (tan δ) at 0° C. of the rubber composition for tires. However, in this way, the glass transition temperature (Tg) of the rubber composition for tires becomes high, and performance on snow and wear resistance may deteriorate. Furthermore, when a large amount of a butadiene rubber is blended to supplement Tg or performance on snow, dispersibility of silica deteriorates, therefore low rolling resistance and wet performance tend to deteriorate. Thus, Patent Document 1 proposes a rubber composition for tires containing a coumarone indene resin having a softening point of 50° C. or lower.

Furthermore, for example, also for a tire used for a large vehicle such as a truck and a bus (hereinafter, may be referred to as “heavy duty tire”), environmental regulations become stricter every year. In Europe, ECE R117-02 was introduced in November 2016, and it has been decided that a similar law is enforced in Japan in 2023. Therefore, reduction of rolling resistance is an issue for a rubber composition for tires for a tread of a heavy duty tire, and silica is often used as a filler. However, a rubber composition for tires for a tread of a heavy duty tire has a high content of a natural rubber. Thus, it is difficult to achieve good dispersibility of silica, and, when dispersibility of silica is poor, durability such as wear resistance and cut resistance that are required for heavy duty tires deteriorates. Patent Document 2 thus proposes use of a rubber composition for tires containing a modified polybutadiene rubber containing an amine-based functional group and a natural rubber for a tread rubber.

However, in recent years, there is increasing demand for a rubber composition for tires providing low rolling resistance and wear resistance in a compatible manner to a high level, and further improvement is demanded.

### CITATION LIST

### Patent Literature

Patent Document 1: JP 2013-139522 A
Patent Document 2: JP 2010-013602 A

### SUMMARY OF INVENTION

### Technical Problem

An object of the present invention is to provide a rubber composition for tires providing low rolling resistance and wear resistance in a compatible manner.

### Solution to Problem

The rubber composition for tires according to an embodiment of the present invention to achieve the object described above is characterized by containing from 30 to 200 parts by mass of silica blended in 100 parts by mass of a diene rubber, the diene rubber containing from 30 to 70 mass % of a modified styrene-butadiene rubber containing an alkoxysilyl group, the modified styrene-butadiene rubber having, when measured by gel permeation chromatography, a molecular weight distribution curve of a unimodal shape and a molecular weight distribution (PDI) of the modified styrene-butadiene rubber being less than 1.7; a vinyl content being from 10 to 45 mass %; and a glass transition temperature of the rubber composition for tires being −50° C. or lower.

### Advantageous Effects of Invention

According to the rubber composition for tires of an embodiment of the present invention, because the present rubber composition includes a diene rubber and silica, the diene rubber containing a modified styrene-butadiene rubber having an alkoxysilyl group, the modified styrene-butadiene rubber having a unimodal molecular weight distribution curve and the molecular weight distribution (PDI) of less than 1.7 as measured by gel permeation chromatography, and because a vinyl content is 10 to 45 mass % and the glass transition temperature is −50° C. or lower, low rolling resistance and wear resistance can be achieved in a compatible manner.

In the rubber composition for tires of an embodiment of the present invention, a rubber composition for tires in which from 60 to 200 parts by mass of silica is blended in 100 parts by mass of a diene rubber containing from 40 to 70 mass % of the modified styrene-butadiene rubber is suitable for use in a tread portion for a winter tire and/or an all-season tire. At this time, tan δ(0° C.)/E′(−20° C.), a ratio between a loss tangent at 0° C., tan δ(0° C.) [-], and a storage modulus at −20° C., E′(−20° C.) [MPa], of the rubber composition for tires may be 0.007 [MPa⁻¹] or more and 0.011 [MPa⁻¹] or less.

In the rubber composition for tires of an embodiment of the present invention, a rubber composition for tires in which from 30 to 70 parts by mass of silica is blended in 100 parts by mass of a diene rubber containing from 30 to 50 mass % of the modified styrene-butadiene rubber and from 70 to 50 mass % of a natural rubber is suitable for use in a tread portion for a heavy duty tire. At this time, the CTAB adsorption specific surface area of the silica is preferably from 100 to 250 m²/g.

### DESCRIPTION OF EMBODIMENTS

The rubber composition for tires contains a modified styrene-butadiene rubber having an alkoxysilyl group in a diene rubber. This modified styrene-butadiene rubber contains an alkoxysilyl group, and when the modified styrene-butadiene rubber is measured by gel permeation chromatography, the molecular weight distribution curve is unimodal and the molecular weight distribution (PDI) is less than 1.7. By blending such a modified styrene-butadiene rubber, dispersibility of silica is improved, and low rolling resistance and wear resistance can be provided together at high levels.

Examples of the alkoxysilyl group contained in the modified styrene-butadiene rubber include an alkoxysilyl group containing an alkoxy having from 1 to 10 carbons. Two or three alkoxy moieties having different numbers of carbons may be contained, or one or two alkyl moieties may be contained. Examples of the alkoxysilyl group include a methoxysilyl group, an ethoxysilyl group, a propoxysilyl group, an isopropoxysilyl group, and a butoxysilyl group. By allowing the modified styrene-butadiene rubber to contain the alkoxysilyl group, high affinity with silica can be achieved, and the dispersibility thereof can be improved.

For the modified styrene-butadiene rubber, when the modified styrene-butadiene rubber is measured by gel permeation chromatography, the molecular weight distribution curve is unimodal and the molecular weight distribution (polydispersity index; PDI) is less than 1.7. When the molecular weight distribution curve of the modified styrene-butadiene rubber is unimodal, high uniformity of the molecule is achieved, and the modified styrene-butadiene rubber is uniformly distributed and dispersed in the diene rubber, and thus higher affinity with silica can be achieved. The molecular weight distribution (PDI) is a ratio (Mw/Mn) of the weight average molecular weight (Mw) to the number average molecular weight (Mn) measured by gel permeation chromatography. When the molecular weight distribution (PDI) is less than 1.7, similarly to the case of the molecular weight distribution curve being unimodal, high uniformity of the molecule is achieved, and the modified styrene-butadiene rubber is uniformly distributed and dispersed in the diene rubber, and thus higher affinity with silica can be achieved. The molecular weight distribution (PDI) is more preferably 1.0 or more and less than 1.7, and more preferably from 1.1 to 1.6. Such a modified styrene-butadiene rubber can be preferably obtained by a continuous polymerization.

In the present specification, when the molecular weight distribution curve, the weight average molecular weight (Mw), and the number average molecular weight (Mn) of the modified styrene-butadiene rubber are measured by gel permeation chromatography, examples of the conditions includes the following:
Instrument: Gel permeation chromatography [GPC: HLC-8020, available from Tosoh Corporation]
Column: GMH-HR-H (available from Tosoh Corporation), two connected in serial
Measurement temperature: 40° C.
Carrier gas: Helium
Flow rate: 5 mmol/L
Sample: 10 mg was dissolved in 10 mL THF
Injection volume: 10 μL
Detector: Differential refractometer (RI-8020)

The modified styrene-butadiene rubber containing the alkoxysilyl group is contained in an amount of 30 to 70 mass %, preferably 45 to 70 mass %, and more preferably 50 to 65 mass %, per 100 mass % of the diene rubber. By allowing 30 mass % or more of the modified styrene-butadiene rubber containing an alkoxysilyl group to be blended, dispersibility of silica can be improved. Furthermore, by allowing 70 mass % or less to be blended, wear resistance can be ensured.

The modified styrene-butadiene rubber has a vinyl content of 10 to 45 mass %, preferably 20 to 45 mass %, more preferably 25 to 45 mass %, and even more preferably 35 to 43 mass %. By setting the vinyl content of the modified styrene-butadiene rubber to 10 mass % or more, low rolling resistance can be ensured. Furthermore, by setting the vinyl content to 45 mass % or less, wear resistance performance can be ensured. In the present specification, the vinyl content of the modified styrene-butadiene rubber can be measured by using a Fourier transform infrared spectrometer (available from Shimadzu Corporation) in accordance with JIS K 6239-2 2017.

The rubber composition for tires may contain another diene rubber besides the modified styrene-butadiene rubber. Examples of such another diene rubber include natural rubber, isoprene rubber, butadiene rubber, unmodified styrene-butadiene rubber, modified styrene-butadiene rubber other than the modified styrene-butadiene rubber described above, styrene-isoprene rubber, isoprene-butadiene rubber, ethylene-propylene-diene copolymer rubber, chloroprene rubber, and acrylonitrile-butadiene rubber. These other diene rubbers may be modified with one or more functional groups. The type of the functional group is not particularly limited, and examples thereof include an epoxy group, carboxy group, amino group, hydroxy group, alkoxy group, silyl group, alkoxysilyl group, amide group, oxysilyl group, silanol group, isocyanate group, isothiocyanate group, carbonyl group, and aldehyde group. Other diene rubber is preferably contained in an amount of 30 to 70 mass %, preferably 30 to 55 mass %, and more preferably 30 to 50 mass %, per 100 mass % of the diene rubber.

Preferred examples of the other diene rubber include a natural rubber, a butadiene rubber, and a styrene-butadiene rubber. The natural rubber, butadiene rubber, and styrene-butadiene rubber are not particularly limited, and those typically used for rubber compositions for tires can be used. Blending natural rubber can ensure wear resistance of a tire. Furthermore, blending butadiene rubber can ensure tire performance on ice and snow. Furthermore, blending styrene-butadiene rubber can ensure wet grip properties of a tire.

The rubber composition for tires contains from 30 to 200 parts by mass of silica in 100 parts by mass of the diene rubber. By blending silica, rolling resistance can be made smaller and wet performance can be improved. Examples of the silica include wet silica (hydrous silicic acid), dry silica (silicic anhydride), calcium silicate, and aluminum silicate. One type of these can be used alone, or a combination of two or more types of these can be used. Furthermore, surface-treated silica, in which the surface of silica is surface-treated by a silane coupling agent, may be also used.

In the rubber composition for tires, a silane coupling agent is preferably blended together with silica, and good dispersibility of silica can be achieved. As the silane coupling agent, a type of silane coupling agent that is typically blended together with silica can be used. The silane coupling agent is blended in an amount of preferably from 5 to 15 mass %, and more preferably from 8 to 12 mass %, of the silica content.

The rubber composition for tires may optionally contain, as other inorganic fillers besides silica, carbon black, calcium carbonate, magnesium carbonate, talc, clay, mica, alumina, aluminum hydroxide, titanium oxide, and calcium sulfate. One type of these other inorganic fillers can be used alone, or a combination of two or more types of these can be used.

In 100 parts by mass of the diene rubber, preferably from 5 to 100 parts by mass, and more preferably from 5 to 80 parts by mass, of the carbon black may be blended. Blending 5 parts by mass or more of the carbon black can ensure tire durability. Additionally, rigidity can be ensured, and rolling resistance can be made small. When the carbon black is blended in 100 parts by mass or less, low rolling resistance can be ensured. A combination of two or more types of the carbon blacks may be used.

The rubber composition for tires has a glass transition temperature of −50° C. or less. By setting the glass transition temperature to −50° C. or less, wear resistance can be ensured. The glass transition temperature is preferably −75° C. or higher and −50° C. or lower, and more preferably −70° C. or higher and −50° C. or lower. The glass transition temperature of the rubber composition for tires can be determined as a temperature at the midpoint of the transition region by measuring a thermogram at a rate of temperature increase of 10° C./min by using a differential scanning calorimeter (available from Shimadzu Corporation) in accordance with JIS K 6240-2011.

The rubber composition for tires may also contain various additives that are commonly used in a rubber composition for tires within a range that does not impair the object of the present invention. Examples thereof include vulcanization or crosslinking agents, vulcanization accelerators, anti-aging agents, plasticizers, processing aids, liquid polymers, and thermosetting resins. These additives may be kneaded by any commonly known method to form a rubber composition for tires, and can be used for vulcanization or crosslinking. Blended amounts of these additives may be any known amount, so long as the objects of the present invention are not hindered.

Rubber Composition for Winter Tires and Rubber Composition for all-Season Tires

The rubber composition for tires of an embodiment of the present invention can suitably constitute tread portions of winter tires and all-season tires. The following characteristics are more preferably included for the rubber composition for winter tires and the rubber composition for all-season tires (hereinafter, these are collectively abbreviated as “rubber composition A for tires”).

In the rubber composition A for tires, preferably from 60 to 200 parts by mass of silica is blended in 100 parts by mass of a diene rubber containing from 40 to 70 mass % of the modified styrene-butadiene rubber. In 100 mass % of the diene rubber, preferably from 40 to 70 mass %, and more preferably from 50 to 65 mass %, of the modified styrene-butadiene rubber is contained. By allowing 40 mass % or more of the modified styrene-butadiene rubber to be contained, dry steering stability and wet braking performance can be ensured. Furthermore, by allowing 70 mass % or less to be contained, braking on snow performance can be ensured.

The rubber composition A for tires preferably contains from 60 to 200 parts by mass, and more preferably from 80 to 160 parts by mass, of silica in 100 parts by mass of the diene rubber. By blending 60 parts by mass or more of silica, wet performance can be ensured. Furthermore, by blending 200 parts by mass or less, wear resistance and low rolling resistance can be ensured.

The modified styrene-butadiene rubber used in the rubber composition A for tires may have the styrene content of preferably from 25 to 40 mass %, and more preferably from 30 to 40 mass %. By setting the styrene content to 25 mass % or more, wet performance can be ensured. Furthermore, by setting the styrene content to 40 mass % or less, snow performance can be ensured. In the present specification, the styrene content of the modified styrene-butadiene rubber can be measured by using a Fourier transform infrared spectrometer (available from Shimadzu Corporation) in accordance with JIS K 6239-2 2017.

The rubber composition A for tires preferably has tan δ(0° C.)/E′(−20° C.), a ratio between a loss tangent at 0° C., tan δ(0° C.) [-], and a storage modulus at −20° C., E′(−20° C.) [MPa], of 0.007 [MPa⁻¹] or more and 0.011 [MPa⁻¹] or less. By setting the ratio tan δ(0° C.)/E′(−20° C.) to 0.007 [MPa⁻¹] or more, snow performance can be ensured. Furthermore, by setting to 0.011 [MPa⁻¹] or less, dry steering stability and wet braking performance can be ensured. In the present specification, the loss tangent tan δ(0° C.) [-] and the storage modulus at −20° C. E′(−20° C.) [MPa] can be measured by using a viscoelasticity analyzer (available from Ueshima Seisakusho Co., Ltd.) in accordance with JIS K 6394-2007 under the following conditions: initial strain: 10%; amplitude: +2%; and frequency: 20 Hz.

### Rubber Composition for Heavy Duty Tires

The rubber composition for tires of an embodiment of the present invention can suitably constitute a tread portion for a heavy duty tire used for a large vehicle such as a truck and a bus. The following characteristics are more preferably included for the rubber composition for heavy duty tires (hereinafter, may be simply abbreviated as “rubber composition B for tires”).

In the rubber composition B for tires, preferably from 30 to 70 parts by mass of silica is blended in 100 parts by mass of a diene rubber containing from 30 to 50 mass % of the modified styrene-butadiene rubber and from 70 to 50 mass % of a natural rubber. In 100 mass % of the diene rubber, preferably from 30 to 50 mass %, and more preferably from 30 to 40 mass %, of the modified styrene-butadiene rubber is contained. By allowing 30 mass % or more of the modified styrene-butadiene rubber to be blended, dispersion of silica can be improved and low rolling resistance can be improved. Furthermore, by allowing 50 mass % or less to be blended, wear resistance can be ensured. In the diene rubber of the rubber composition B for tires, the total amount of the modified styrene-butadiene rubber and the natural rubber is preferably 100 mass %.

The rubber composition B for tires preferably contains from 30 to 70 parts by mass, and more preferably from 40 to 60 parts by mass, of silica in 100 parts by mass of the diene rubber. By blending 30 parts by mass or more of silica, wear resistance is improved. Furthermore, by blending 70 parts by mass or less, low rolling resistance is improved.

The silica contained in the rubber composition B for tires has a CTAB adsorption specific surface area of preferably 100 to 250 m²/g, and more preferably 150 to 200 m²/g. By setting the CTAB adsorption specific surface area of silica to 100 m²/g or more, wear resistance is improved. Furthermore, when the CTAB adsorption specific surface area is 250 m²/g or less, low rolling resistance is improved. In the present specification, the CTAB adsorption specific surface area is measured in accordance with JIS K 6217-3.

The rubber composition for tires described above is preferably a rubber composition for tire tread and can suitably constitute a tread portion of a tire. A tire having a tread portion made of the rubber composition for tires of an embodiment of the present invention can provide low rolling resistance and wear resistance in a compatible manner. Note that the tire may be a pneumatic tire or a non-pneumatic tire.

Embodiments according to the present invention are further described below by Examples. However, the scope of the present invention is not limited to these Examples.

### EXAMPLES

Rubber Composition for Winter Tires and Rubber Composition for all-Season Tires

Each of the rubber compositions for tires (Examples 1 to 6, Standard Examples 1 and 2, and Comparative Examples 1 to 8) was prepared according to the formulations presented in Tables 1 and 2 with the compounding agents presented in Table 3 used as common components. With the exception of the sulfur and the vulcanization accelerators, the components were kneaded in a 1.7 L sealed Banbury mixer for 5 minutes, then discharged from the mixer, and cooled at room temperature. This was placed in the 1.7 L sealed Banbury mixer described above, and the sulfur and the vulcanization accelerators were then added and mixed, and thus rubber compositions for tires were prepared. Furthermore, the blended amounts of the compounding agents presented in Table 3 are expressed as values in part by mass per 100 parts by mass of the diene rubbers presented in Tables 1 and 2.

In addition, the obtained rubber compositions for tires were vulcanized in a mold of 15 cm×15 cm×0.2 cm at 160° C. for 20 minutes to prepare vulcanized rubber sheets, and dynamic visco-elasticity and wear resistance were measured by the following methods.

### Dynamic Visco-Elasticity

For the dynamic visco-elasticity of the vulcanized rubber sheets obtained as described above, tan δ(0° C.) [-], a loss tangent at 0° C., and E′(−20° C.) [MPa], a storage modulus at −20° C., were determined by using a viscoelasticity spectrometer, available from Toyo Seiki Seisaku-sho, Ltd., at an initial strain of 10%, an amplitude of +2%, and a frequency of 20 Hz. Furthermore, the ratio tan δ(0° C.)/E′(−20° C.) [1/MPa] was calculated. The obtained results are presented on rows of Tables 1 and 2.

### Wear Resistance

For the vulcanized rubber sheets obtained as described above, wear resistance test was performed in accordance with JIS K 6264-2:2005 using a Lambourn abrasion test machine (available from Iwamoto Seisakusho Co., Ltd.) under the following conditions to measure wear mass: applied force: 4.0 kg/cm³ (=39 N); slip rate: 30%; duration of wear resistance test: 4 minutes; and test temperature: room temperature. The reciprocal thereof was calculated. The obtained results are presented on the “Wear resistance” rows of Tables 1 and 2 as index values, with a value of Standard Example 1 being 100 for Table 1 and with a value of Standard Example 2 being 100 for Table 2. The larger these index values, the better the wear resistance.

### Braking on Snow Performance

Tires each produced by using a tire tread of the rubber compositions and having a size of 205/55R16 were mounted on a test vehicle, in which an ABS was installed, and which had an engine displacement of 2000 cc, by inflating front tires and rear tires to an air pressure of 220 kPa. The test vehicle was driven on a compacted snow road surface, and a braking distance when braking was performed at an initial velocity of 40 km/hr was measured. Each of the obtained results was expressed as an index value determined by calculating a reciprocal thereof, with a value of Standard Example 1 being assigned the value of 100 in Table 1 and a value of Standard Example 2 being assigned the value of 100 in Table 2, and presented in the “Braking on snow performance” rows in Tables 1 and 2. The larger these index values, the better the braking on snow performance.

### Dry Steering Stability

Tires each produced by using a tire tread of the rubber compositions and having a size of 205/55R16 were mounted on a test vehicle, in which an ABS was installed, and which had an engine displacement of 2000 cc, by inflating front tires and rear tires to an air pressure of 220 kPa. The test vehicle was driven on a dry road surface with relatively less protrusions and recesses, and responsiveness when a steering wheel was turned was subjected to sensory evaluation. The obtained results are presented on the “Dry steering stability” rows of Tables 1 and 2 as index values, with a value of Standard Example 1 being 100 for Table 1 and with a value of Standard Example 2 being 100 for Table 2. The larger these index values, the better the dry steering stability.

### Wet Braking Performance

Tires each produced by using a tire tread of the rubber compositions and having a size of 205/55R16 were mounted on a test vehicle, in which an ABS was installed, and which had an engine displacement of 2000 cc, by inflating front tires and rear tires to an air pressure of 220 kPa. A braking distance from a velocity of 100 km/h on an asphalt road surface where water was sprinkled in a manner that the water depth became 2.0 to 3.0 mm was measured. Each of the obtained results was expressed as an index value determined by calculating a reciprocal thereof, with a value of Standard Example 1 being assigned the value of 100 in Table 1 and a value of Standard Example 2 being assigned the value of 100 in Table 2, and presented in the “Wet braking performance” rows in Tables 1 and 2. The larger these index values, the better the wet braking performance.

### Low Rolling Resistance

For the dynamic visco-elasticity of the vulcanized rubber sheets obtained as described above, a loss tangent at 60° C., tan δ (60° C.), was measured by using a viscoelasticity spectrometer, available from Toyo Seiki Seisaku-sho, Ltd., at an initial strain of 10%, an amplitude of ±2%, and a frequency of 20 Hz, and a reciprocal thereof was determined. The obtained results are presented on the “Low rolling resistance” rows of Tables 1 and 2 as index values, with a value of Standard Example 1 being 100 for Table 1 and with a value of Standard Example 2 being 100 for Table 2. The larger these index values, the better the low rolling resistance.

TABLE 1

| | | | | | | Compar- | Compar- | Compar- | Compar- |
|---|---|---|---|---|---|---|---|---|---|
| | | Standard | Example | Example | Example | ative | ative | ative | ative |
| | | Example 1 | 1 | 2 | 3 | Example 1 | Example 2 | Example 3 | Example 4 |
| Modified SBR-1 | parts by mass | 60 | | | | | | | |
| Modified SBR-2 | parts by mass | | 60 | 60 | 60 | 75 | 25 | | 60 |
| Modified SBR-3 | parts by mass | | | | | | | 60 | |
| NR | parts by mass | 15 | 15 | 15 | 15 | 10 | 25 | 15 | 15 |
| BR | parts by mass | 25 | 25 | 25 | 25 | 15 | 50 | 25 | 25 |
| Silica-1 | parts by mass | 80 | 80 | 120 | 160 | 80 | 80 | 80 | 220 |
| Carbon black-1 | parts by mass | 5 | 5 | 5 | 5 | 5 | 5 | 5 | 5 |
| Coupling agent-1 | parts by mass | 6.5 | 6.5 | 8.0 | 9.5 | 6.5 | 6.5 | 6.5 | 13 |
| Aroma oil | parts by mass | 10 | 10 | 20 | 30 | 5 | 5 | 10 | 50 |
| Tg of rubber composition | ° C. | −53 | −53 | −52 | −51 | −45 | −75 | −52 | −51 |
| tanδ(0° C.) | — | 0.45 | 0.50 | 0.55 | 0.60 | 0.65 | 0.40 | 0.45 | 0.65 |
| E′(−20° C.) | MPa | 65 | 65 | 65 | 65 | 95 | 35 | 65 | 95 |
| tanδ(0° C.)/E′(−20° C.) | 1/MPa | 0.0069 | 0.0077 | 0.0085 | 0.0092 | 0.0068 | 0.0114 | 0.0069 | 0.0068 |
| Braking on snow performance | index value | 100 | 106 | 104 | 102 | 97 | 120 | 102 | 95 |
| Dry steering stability | index value | 100 | 105 | 108 | 110 | 112 | 95 | 100 | 112 |
| Wet braking performance | index value | 100 | 105 | 108 | 110 | 110 | 95 | 102 | 115 |
| Wear resistance | index value | 100 | 110 | 106 | 102 | 101 | 110 | 98 | 95 |
| Low rolling resistance | index value | 100 | 115 | 110 | 106 | 110 | 120 | 100 | 97 |

TABLE 2

| | | | | | | Compar- | Compar- | Compar- | Compar- |
|---|---|---|---|---|---|---|---|---|---|
| | | Standard | Example | Example | Example | ative | ative | ative | ative |
| | | Example 2 | 4 | 5 | 6 | Example 5 | Example 6 | Example 7 | Example 8 |
| Modified SBR-3 | parts by mass | | | | | | | 60 | |
| SBR-4 | parts by mass | 60 | | | | | | | |
| Modified SBR-5 | parts by mass | | 60 | 60 | 60 | 75 | 25 | | 60 |
| BR | parts by mass | 40 | 40 | 40 | 40 | 25 | 75 | 40 | 40 |
| Silica-2 | parts by mass | 100 | 100 | 130 | 160 | 100 | 100 | 100 | 220 |
| Carbon black-1 | parts by mass | 5 | 5 | 5 | 5 | 5 | 5 | 5 | 5 |
| Coupling agent-1 | parts by mass | 8.0 | 8.0 | 10.5 | 13.0 | 8.0 | 8.0 | 8.0 | 18 |
| Aroma oil | parts by mass | 10 | 10 | 20 | 30 | 10 | 10 | 10 | 50 |
| Tg of rubber composition | ° C. | −81 | −71 | −68 | −66 | −64 | −87 | −58 | −63 |
| tanδ(0° C.) | — | 0.40 | 0.50 | 0.55 | 0.60 | 0.50 | 0.35 | 0.70 | 0.65 |
| E′(−20° C.) | MPa | 60 | 65 | 75 | 85 | 75 | 30 | 85 | 95 |
| tanδ(0° C.)/E′(−20° C.) | 1/MPa | 0.0067 | 0.0077 | 0.0073 | 0.0071 | 0.0067 | 0.0117 | 0.0082 | 0.0068 |
| Braking on snow performance | index value | 100 | 106 | 104 | 102 | 97 | 120 | 92 | 98 |
| Dry steering stability | index value | 100 | 105 | 108 | 110 | 105 | 95 | 110 | 112 |
| Wet braking performance | index value | 100 | 105 | 108 | 110 | 108 | 95 | 110 | 115 |
| Wear resistance | index value | 100 | 110 | 106 | 102 | 105 | 108 | 90 | 97 |
| Low rolling resistance | index value | 100 | 109 | 107 | 105 | 108 | 97 | 95 | 98 |

TABLE 3
Common additive formulation of
rubber composition of Tables 1 and 2

| | |
|---|---|
| Stearic acid | 2.0 parts by mass |
| Zinc oxide | 3.0 parts by mass |
| Anti-aging agent | 4.0 parts by mass |
| Sulfur | 1.0 part by mass |
| Vulcanization accelerator-1 | 2.0 parts by mass |
| Vulcanization accelerator-2 | 1.0 part by mass |

For Tables 1 to 3, the types of used raw materials are as follows.
Modified SBR-1: Styrene-butadiene rubber containing a hydroxy group; Tufdene E581, available from Asahi Kasei Corporation; Glass transition temperature: −31° C.; molecular weight distribution curve measured by gel permeation chromatography (GPC) was unimodal, and molecular weight distribution (PDI) thereof was 2.3; styrene content was 37 mass %; vinyl content was 42 mass %.
Modified SBR-2: Styrene-butadiene rubber containing an alkoxysilyl group; rubber produced in Polymerization Examples 1; Glass transition temperature: −31° C.; molecular weight distribution curve measured by GPC was unimodal, and molecular weight distribution (PDI) thereof was 1.3; styrene content was 36 mass %; vinyl content was 42 mass %.
Modified SBR-3: Styrene-butadiene rubber containing an alkoxysilyl group; NS540, available from Zeon Corporation; Glass transition temperature: −29° C.; molecular weight distribution curve measured by GPC was bimodal, and molecular weight distribution (PDI) thereof was 1.9; styrene content was 42 mass %; vinyl content was 30 mass %.
SBR-4: Unmodified styrene-butadiene rubber; Tufdene 1834, available from Asahi Kasei Corporation; Glass transition temperature: −72° C.; molecular weight distribution curve measured by GPC was unimodal, and molecular weight distribution (PDI) thereof was 2.9; styrene content was 19 mass %; vinyl content was 10 mass %.
Modified SBR-5: Styrene-butadiene rubber containing an alkoxysilyl group; rubber produced in Polymerization Examples 2; Glass transition temperature: −53° C.; molecular weight distribution curve measured by GPC was unimodal, and molecular weight distribution (PDI) thereof was 1.5; styrene content was 25 mass %; vinyl content was 28 mass %.
NR: Natural rubber, TSR 20, glass transition temperature was −65° C.
BR: Butadiene rubber; Nipol BR1220, available from Zeon Corporation, glass transition temperature was −105° C.
Silica-1: Ultrasil 9100GR, available from Evonik Industries AG
Silica-2: ZEOSIL 1165MP, available from Solvay
Carbon black-1: SEAST 7HM N234, available from Tokai Carbon Co., Ltd.
Coupling agent-1: Si69, available from Evonik Degussa, bis(triethoxysilylpropyl)tetrasulfide
Aroma oil: Extract No. 4S, available from Showa Shell Sekiyu K.K.
Stearic acid: beads stearic acid, available from NOF Corporation
Zinc oxide: Zinc Oxide III, available from Seido Chemical Industry Co., Ltd.
Anti-aging agent: 6PPD, available from Korea Kumho Petrochemical
Sulfur: Golden Flower oil treated sulfur powder, available from Tsurumi Chemical Industry Co., Ltd.
Vulcanization accelerator-1: NOCCELER CZ-G, available from Ouchi Shinko Chemical Industrial Co., Ltd.
Vulcanization accelerator-2: Soxinol D-G, available from Sumitomo Chemical Co., Ltd.

### Production Example 1

Two vacuum dried 4 L stainless steel pressure vessels were prepared. In a first pressure vessel, 6922 g of cyclohexane, 85 g of a compound represented by Chemical Formula (1) below, and 60 g of tetramethylethylenediamine were charged, and a first reaction solution was produced. At the same time, in a second pressure vessel, 180 g of 2.0 M liquid n-butyllithium and 6926 g of cyclohexane were charged, and thus a second reaction solution was produced. At this time, the molar ratio of the compound represented by Chemical Formula (1) to the n-butyllithium to the tetramethylethylenediamine was 1:1:1. In a condition where the pressure of each of the pressure vessels was maintained at 7 bar, using a mass flowmeter, the first reaction solution was charged in a continuous reactor through a first continuous channel at an injection rate of 1.0 g/min and the second reaction solution was charged in the continuous reactor through a second continuous channel at an injection rate of 1.0 g/min. At this time, the temperature in the continuous reactor was maintained at −10° C., the internal pressure was maintained at 3 bar by using a back pressure regulator, and the retention time in the reactor was adjusted to 10 minutes or less. The reaction was terminated, and thus a modification initiator was obtained.

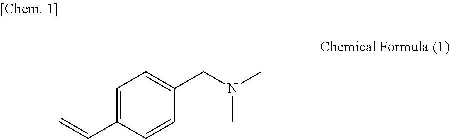

### Polymerization Example 1

In a first reactor in a continuous reactor in which three reactors were connected in series, injection was performed at 6.5 kg/h for a styrene solution in which 60 wt. % of styrene was dissolved in n-hexane, at 7.7 kg/h for a 1,3-butadiene solution in which 60 wt. % of 1,3-butadiene was dissolved in n-hexane, at 47.0 kg/h for n-hexane, at 40 g/h for 1,2-butadiene solution in which 2.0 wt. % of 1,2-butadiene was dissolved in n-hexane, at 50.0 g/h for a solution in which 10 wt. % of N,N,N′,N′-tetramethylethylenediamine (TMEDA) was dissolved in n-hexane as a polar additive, and at 400.0 g/h for the modification initiator produced in Production Example 1 below. At this time, the temperature of the first reactor was maintained at 55° C., and when the polymerization conversion ratio became 41%, the polymerized material was transferred from the first reactor to the second reactor through a transfer pipe.

Then, in a second reactor, injection was performed at a rate of 2.3 kg/h for a 1,3-butadiene solution in which 60 wt. % of 1,3-butadiene was dissolved in n-hexane. At this time, the temperature of the second reactor was maintained at 65° C., and when the polymerization conversion ratio became 95% or higher, the polymerized material was transferred from the second reactor to the third reactor through a transfer pipe.

The polymerized material was transferred from the second reactor to the third reactor, and a solution in which N-(3-(1H-1,2,4-triazol-1-yl) propyl)-3-(trimethoxysilyl)-N-(3-(trimethoxysilyl) propyl) propane-1-amine was dissolved (solvent: n-hexane) as a modifying agent was charged continuously in the third reactor [modifying agent: act. Li (polymerization initiator)=1:1 mol]. The temperature of the third reactor was maintained at 65° C.

Thereafter, in the polymerization solution discharged from the third reactor, a solution in which 30 wt. % of IR1520 (available from BASF) was dissolved as an antioxidant was injected at a rate of 170 g/h and agitated. The polymerized material obtained as a result of this was charged in warm water heated by steam, the solvent was removed by agitation, and thus a modified conjugated diene polymer (modified SBR-2) was produced.

### Polymerization Example 2

A modified conjugated diene-based polymer (modified SBR-5) was produced in the same manner as in Polymerization Example 1 except for performing continuous charging, into the first reactor, at 4.6 kg/h for a styrene solution in which 60 wt. % of styrene was dissolved in n-hexane, at 11.5 kg/h for a 1,3-butadiene solution in which 60 wt. % of 1,3-butadiene was dissolved in n-hexane, at 40.0 g/h for a solution in which 10 wt. % of N,N,N′,N′-tetramethylethylenediamine (TMEDA) was dissolved in n-hexane as a polar additive, in Polymerization Example 1 described above [coupling agent: act. Li (polymerization initiator)=1:1 mol].

As can be seen from Table 1, it was confirmed that the rubber compositions for tires of Examples 1 to 3 that were suitable for all-season tires had excellent low rolling resistance and wear resistance. Furthermore, excellent braking on snow performance, dry steering stability, and wet braking performance, which are required for an all-season tire, are achieved.

The rubber composition for tires of Comparative Example 1 exhibited poor braking on snow performance because the amount of the modified styrene-butadiene rubber (modified SBR-2) was more than 70 mass % and the glass transition temperature (Tg) of the rubber composition was higher than −50° C.

The rubber composition for tires of Comparative Example 2 exhibited poor dry steering stability and wet braking performance because the amount of the modified styrene-butadiene rubber (modified SBR-2) was less than 30 mass %.

The rubber composition for tires of Comparative Example 3 exhibited poor wear resistance because the molecular weight distribution curve of the modified styrene-butadiene rubber (modified SBR-3) was bimodal, and the molecular weight distribution (PDI) was more than 1.7.

Because the rubber composition for tires of Comparative Example 4 contained more than 200 parts by mass of the silica, wear resistance and low rolling resistance were poor.

As can be seen from Table 2, it was confirmed that the rubber compositions for tires of Examples 4 to 6 that were suitable for winter tires had excellent low rolling resistance and wear resistance. Furthermore, excellent braking on snow performance, dry steering stability, and wet braking performance, which are required for a winter tire, were achieved.

The rubber composition for tires of Comparative Example 5 exhibited poor braking on snow performance because the amount of the modified styrene-butadiene rubber (modified SBR-5) was more than 70 mass %.

The rubber composition for tires of Comparative Example 6 exhibited poor dry steering stability and wet braking performance because the amount of the modified styrene-butadiene rubber (modified SBR-5) was less than 30 mass %.

The rubber composition for tires of Comparative Example 7 exhibited poor wear resistance, low rolling resistance, and braking on snow performance because the molecular weight distribution curve of the modified styrene-butadiene rubber (modified SBR-3) was bimodal, and the molecular weight distribution (PDI) was more than 1.7.

Because the rubber composition for tires of Comparative Example 8 contained more than 200 parts by mass of the silica, wear resistance and low rolling resistance were poor.

### Rubber Composition for Heavy Duty Tires

Each of the rubber compositions for tires (Examples 7 to 12, Standard Example 3, and Comparative Examples 9 to 14) was prepared according to the formulations presented in Tables 4 and 5 with the compounding agents presented in Table 6 used as common components. With the exception of sulfur and vulcanization accelerators, the components were kneaded in a 1.7 L sealed Banbury mixer for 5 minutes, then discharged from the mixer, and cooled at room temperature. This was placed in the 1.7 L sealed Banbury mixer described above, and the sulfur and the vulcanization accelerators were then added and mixed, and thus a rubber composition for tires was prepared. The blended amounts of the compounding agents presented in Table 6 are expressed as values in parts by mass with respect to 100 parts by mass of the diene rubbers presented in Tables 4 and 5.

In addition, the obtained rubber compositions for tires were vulcanized in a mold of 15 cm×15 cm×0.2 cm at 160° C. for 20 minutes to prepare vulcanized rubber sheets, and wear resistance and low rolling resistance (dynamic visco-elasticity) were measured by the following methods.

### Wear Resistance

For the vulcanized rubber sheets obtained as described above, a wear resistance test was performed in accordance with JIS K 6264-2:2005 using a Lambourn abrasion test machine (available from Iwamoto Seisakusho Co., Ltd.) under the following conditions to measure wear mass: applied force: 4.0 kg/cm³ (=39 N); slip rate: 30%; duration of wear resistance test: 4 minutes; and test temperature: room temperature. The reciprocal thereof was calculated. The obtained results are presented on the “Wear resistance” rows of Tables 4 and 5 as index values, with a value of Standard Example 3 being 100. The larger these index values, the better the wear resistance.

### Low Rolling Resistance (Dynamic Visco-Elasticity)

For the dynamic visco-elasticity of the vulcanized rubber sheets obtained as described above, a loss tangent at 60° C., tan δ (60° C.), was measured by using a viscoelasticity spectrometer, available from Toyo Seiki Seisaku-sho, Ltd., at an initial strain of 10%, an amplitude of +2%, and a frequency of 20 Hz, and a reciprocal thereof was determined. The obtained results are presented on the “Low rolling resistance” rows of Tables 4 and 5 as index values, with a value of Standard Example 3 being 100. The larger these index values, the better the low rolling resistance.

TABLE 4

| | | Standard | Comparative | Comparative | Comparative | Comparative | Comparative | Comparative |
|---|---|---|---|---|---|---|---|---|
| | | Example 3 | Example 9 | Example 10 | Example 11 | Example 12 | Example 13 | Example 14 |
| Modified SBR-1 | parts by mass | | | 30 | | | | |
| Modified SBR-2 | parts by mass | | | | 80 | 5 | 50 | |
| Modified SBR-3 | parts by mass | | | | | | | 30 |
| Modified SBR-6 | parts by mass | | 30 | | | | | |
| NR | parts by mass | 100 | 70 | 70 | 20 | 95 | 50 | 70 |
| Silica-2 | parts by mass | 50 | 50 | 50 | 50 | 50 | 50 | 50 |
| Carbon black-2 | parts by mass | 5 | 5 | 5 | 5 | 5 | 5 | 5 |
| Coupling agent-1 | parts by mass | 4 | 4 | 4 | 4 | 4 | 4 | 4 |
| Tg of rubber composition | ° C. | −60 | −52 | −51 | −37 | −59 | −46 | −51 |
| Wear resistance | index value | 100 | 98 | 99 | 82 | 99 | 98 | 96 |
| Low rolling resistance | index value | 100 | 105 | 100 | 123 | 100 | 104 | 103 |

TABLE 5

| | | Example 7 | Example 8 | Example 9 | Example 10 | Example 11 | Example 12 |
|---|---|---|---|---|---|---|---|
| Modified SBR-2 | parts by mass | 30 | | | 30 | 30 | 30 |
| Modified SBR-5 | parts by mass | | 30 | 50 | | | |
| NR | parts by mass | 70 | 70 | 50 | 70 | 70 | 70 |
| Silica-2 | parts by mass | 50 | 50 | 50 | 30 | 65 | |
| Silica-3 | parts by mass | | | | | | 50 |
| Carbon black-2 | parts by mass | 5 | 5 | 5 | 5 | 5 | 5 |
| Coupling agent-1 | parts by mass | 4 | 4 | 4 | 2.4 | 5.2 | 4 |
| Tg of rubber composition | ° C. | −51 | −58 | −57 | −51 | −51 | −51 |
| Wear resistance | index value | 107 | 105 | 103 | 103 | 101 | 112 |
| Low rolling resistance | index value | 110 | 113 | 118 | 125 | 101 | 103 |

TABLE 6
Common additive formulation of
rubber composition of Tables 4 and 5

| | |
|---|---|
| Stearic acid | 2.0 parts by mass |
| Zinc oxide | 3.0 parts by mass |
| Anti-aging agent | 2.0 parts by mass |
| Sulfur | 2.0 parts by mass |
| Vulcanization accelerator-1 | 2.0 parts by mass |
| Vulcanization accelerator-2 | 0.2 parts by mass |

For Tables 4 to 6, the types of raw materials used are as follows.
Modified SBR-1: Styrene-butadiene rubber containing a hydroxy group; Tufdene E581, available from Asahi Kasei Corporation; Glass transition temperature: −31° C.; molecular weight distribution curve measured by gel permeation chromatography (GPC) was unimodal, and molecular weight distribution (PDI) thereof was 2.3; styrene content was 37 mass %; vinyl content was 42 mass %.
Modified SBR-2: Styrene-butadiene rubber containing an alkoxysilyl group; rubber produced in Polymerization Examples 1 described above; Glass transition temperature: −31° C.; molecular weight distribution curve measured by GPC was unimodal, and molecular weight distribution (PDI) thereof was 1.3; styrene content was 36 mass %; vinyl content was 42 mass %.
Modified SBR-3: Styrene-butadiene rubber containing an alkoxysilyl group; NS540, available from Zeon Corporation; Glass transition temperature: −29° C.; molecular weight distribution curve measured by GPC was bimodal, and molecular weight distribution (PDI) thereof was 1.9; styrene content was 42 mass %; vinyl content was 30 mass %.
Modified SBR-5: Styrene-butadiene rubber containing an alkoxysilyl group; rubber produced in Polymerization Examples 2 described above; Glass transition temperature: −53° C.; molecular weight distribution curve measured by GPC was unimodal, and molecular weight distribution (PDI) thereof was 1.5; styrene content was 25 mass %; vinyl content was 28 mass %.
Modified SBR-6: Styrene-butadiene rubber containing an alkoxysilyl group; NS560, available from Zeon Corporation; Glass transition temperature: −32° C.; molecular weight distribution curve measured by GPC was bimodal, and molecular weight distribution (PDI) thereof was 1.5; styrene content was 41 mass %; vinyl content was 29 mass %.
NR: Natural rubber, TSR 20, glass transition temperature was −65° C.
Silica-2: ZEOSIL 1165MP, available from Solvay; CTAB adsorption specific surface area: 160 m²/g
Silica-3: Premium 200MP, available from Solvay; CTAB adsorption specific surface area: 200 m²/g
Carbon black-2: Niteron #300IH, available from NSCC Carbon Co., Ltd.; N2SA: 115 m²/g
Coupling agent-1: Si69, available from Evonik Degussa, bis(triethoxysilylpropyl)tetrasulfide
Stearic acid: beads stearic acid, available from NOF Corporation
Zinc oxide: Zinc Oxide III, available from Seido Chemical Industry Co., Ltd.
Anti-aging agent: Santoflex 6PPD, available from Flexsys
Sulfur: MUCRON OT-20, available from Shikoku Chemicals Corporation.
Vulcanization accelerator-1: NOCCELER CZ-G, available from Ouchi Shinko Chemical Industrial Co., Ltd.
Vulcanization accelerator-2: Perkacit DPG, available from Flexsys

As can be seen from Tables 4 and 5, it was confirmed that the rubber compositions for tires of Examples 7 to 12 that were suitable for heavy duty tires had excellent low rolling resistance and wear resistance.

The rubber composition for tires of Comparative Example 9 exhibited poor wear resistance because the molecular weight distribution curve of the modified styrene-butadiene rubber (modified SBR-6) was bimodal.

The rubber composition for tires of Comparative Example 10 did not achieve effects of wear resistance and low rolling resistance because the molecular weight distribution (PDI) of the modified styrene-butadiene rubber (modified SBR-1) was more than 1.7.

The rubber composition for tires of Comparative Example 11 exhibited poor wear resistance because the amount of the modified styrene-butadiene rubber (modified SBR-2) was more than 70 mass % and the Tg of the rubber composition was higher than −50° C.

The rubber composition for tires of Comparative Example 12 did not achieve effects of wear resistance and low rolling resistance because the amount of the modified styrene-butadiene rubber (modified SBR-2) was less than 30 mass %.

The rubber composition for tires of Comparative Example 13 exhibited poor wear resistance because the Tg of the rubber composition was higher than −50° C.

The rubber composition for tires of Comparative Example 14 exhibited poor wear resistance because the molecular weight distribution curve of the modified styrene-butadiene rubber (modified SBR-3) was bimodal, and the molecular weight distribution (PDI) was more than 1.7.

1. A rubber composition for tires, comprising from 30 to 200 parts by mass of silica blended in 100 parts by mass of a diene rubber, the diene rubber comprising from 30 to 70 mass % of a modified styrene-butadiene rubber containing an alkoxysilyl group,
the modified styrene-butadiene rubber having, when measured by gel permeation chromatography, a molecular weight distribution curve of a unimodal shape, and a molecular weight distribution (PDI) of the modified styrene-butadiene rubber being less than 1.7;
a vinyl content being from 10 to 45 mass %; and
a glass transition temperature of the rubber composition for tires being-50° C. or lower.

2. The rubber composition for tires according to claim 1, wherein from 60 to 200 parts by mass of silica is blended in 100 parts by mass of a diene rubber containing from 40 to 70 mass % of the modified styrene-butadiene rubber.

3. The rubber composition for tires according to claim 1, wherein tan δ(0° C.)/E′(−20° C.), a ratio between a loss tangent at 0° C., tan δ(0° C.) [-], and a storage modulus at −20° C., E′(−20° C.) [MPa], of the rubber composition for tires is 0.007 [MPa⁻¹] or more and 0.011 [MPa⁻¹] or less.

4. The rubber composition for tires according to claim 1, wherein from 30 to 70 parts by mass of silica is blended in 100 parts by mass of a diene rubber, the diene rubber containing from 30 to 50 mass % of the modified styrene-butadiene rubber and from 70 to 50 mass % of a natural rubber.

5. The rubber composition for tires according to claim 4, wherein a CTAB adsorption specific surface area of the silica is from 100 to 250 m²/g.
